(19) United States
(12) Patent Application Publication
(10) Pub. No.: US 2002/0019782 A1
(43) Pub. Date: Feb. 14, 2002

(54) Shopping method

(76) Inventor: Arie Hershtik, Rishon LeZion (IL)

Correspondence Address: Dekel Patent Ltd., 12 HaEgoz Street, Apt. 4, Rehovot, IL

(21) Appl. No.: 09/910,015

(22) Filed: Jul. 23, 2001

Related U.S. Application Data
(60) Provisional application No. 60/222,911, filed on Aug. 4, 2000.

(51) Int. Cl. G06F 17/60

(52) U.S. Cl. 705/26

(57) ABSTRACT

A method including placing an order of at least one shop selected item with a shop, the at least one shop selected item including a purchasable item that a consumer relies on the shop to select from a group of mutually equivalent items without the consumer having to see and select the purchasable item, and going to the shop and choosing at least one personally selected item, the at least one personally selected item including a purchasable item that a consumer does not rely on the shop to select.

### FIELD OF THE INVENTION

This invention is directed to electronic commerce in general, and particularly to a distributed order entry system and method.

More specifically the invention relates to a system and apparatus that substantially improve the process of purchasing food or common household items, reduce labor and space expenses of the retailers, alleviating store load and maintain store loyalty.

### BACKGROUND OF THE INVENTION

Purchasing food or common household items over the Internet or telemarketing systems is well known in the art. However, such purchasing has met with limited acceptance for various reasons. Most of the population may not use the Internet in the foreseeable future, and the Internet is not simple, accessible, or fast enough. Typical e-commerce is based on home delivery and electronic payment, but most buyers prefer to personally select certain items, such as fruits, vegetables, etc., and they say, “I'll go to the shop anyway so I'll take everything together.”

Additionally, electronic payment methods are still subject to widespread fear and prejudice. Electronic purchasing often results in shipping errors and in cancellations of shipped orders due to client denials or satisfaction guarantees.

Therefore, most buyers do not use the existing e-commerce methods. Instead they prepare a shopping list, trudge to the store, select their products, stand in line and pay for their products.

Preparing the purchasing list of food or common household items is a process that most buyers do manually. They simply write the list on a piece of paper shortly before going to the shop, or continuously write the list during the week whenever they remember. However, often after return from shopping, one may hear “Oh, I forgot”.

### SUMMARY OF THE INVENTION

The present invention discloses a method, system and apparatus that overcome the problems of the prior art systems, while alleviating store load and maintaining store loyalty. The present invention employs two groups of shopping items, which appear on the purchasing list of the typical buyer: simple known items and selected items.

In the prior art, the process of loading the simple items into the basket and going through the checkout counter takes a substantially long time. Moreover, when the basket is full, the customer psychologically tends to stop buying.

Retailers, such as supermarkets, for example, have a clear interest in drawing clients to their store, so that the client may be exposed to new products, and generally to maintain customer loyalty. On the other hand, retailers have to pay for extra staff, checkout equipment, larger stocks, and larger shelf volume, and suffer at times from overcrowded stores that deter repeated customer visits.

However, many products, mostly standard packaged items, such as a box of a favorite cereal, or a soft drink, for example, are known entities and no selection is deemed to be needed by the customer (or user, consumer or client, the terms being used interchangeably throughout) since one is presumed to be identical to the other. Clients may often gladly receive all such “store select” products without personally removing them from the shelves.

The system and apparatus of the present invention enables the customer to prepare the purchasing list simply and easily, and to transfer the list quickly and efficiently to the shop that may prepare the simple products and pack them to be collected. The invention thus tends to save time in the shop, increase sales, save shop space, save labor, keep customer loyalty and substantially improve the whole shopping process.

Therefore, it is an object of the present invention to provide a new electronic purchasing system and method that overcome the disadvantages of the prior art, and promote the advantages of electronic commerce.

It is another object of the present invention to provide a computerized apparatus that may be placed in the kitchen and used as an electronic notepad for simple and continuous entry of lists of desired products.

It is another object of the present invention to provide an apparatus that may include an electronic, continuously updated catalog of the products offered by the retailer.

It is still another object of the present invention to provide an apparatus that may be connected via a communication link capable of communication with a specific store counterpart server and provide bidirectional data flow.

It is still another object of the present invention to provide a system and method that may save substantial customer time, which is lost in the prior art shopping process.

Other objects of the present invention include providing a system and method that enable the retailer to keep customers loyal, save shelf space, save a major part of the expenses and labor wasted to place simple products on the shelves, save expenses and labor needed at the checkout counters, save expenses needed for extra checkout counter equipment, and improve efficiency and service.

The present invention seeks to provide an improved distributed order entry system and method that accomplish all the abovementioned objects and many more features and advantages as described further hereinbelow.

In one embodiment of the invention, the system may comprise four major components: 1) home apparatus, 2) communication link, 3) store computerized system and accessories, and 4) software.

The home apparatus may be a computerized, dedicated device, but may also comprise a personal digital assistant (PDA) equipped with a communication link, which may be placed in the kitchen, e.g., magnetically attached to a refrigerator. The device may be used as a notepad for entry of lists of desired products.

The communication link may comprise a telephone line, cellular or radio communications link, cable, or any other communications link capable of effecting communication between the device and the specific store computer server, and providing bidirectional data flow.

The store-computerized system may comprise three major parts: a main server, a packing zone display, and a shop entrance display.

The software is preferably purposely designed to enable all the abovementioned hardware to operate according to the desired purchasing method, and to enable the parties to accomplish all the benefits of the system as described.

Whenever the home apparatus is switched on, it may be automatically connected to the shop server, updated with any new information (products, prices, etc.) and disconnected. The user may select the products and quantities desired. For example, a request for cooking oil may bring out or display a selection of all the available cooking oils in the store, whereupon the user may select a desired oil. Alternatively, the user may indicate a desired “default” which may be the brand that the user purchases regularly, and which may be stored in the device or server memory. Another alternative selection includes, for example, a “don't care” option, in which case the store may select one from that category for the client, or a “least expensive” option. While using the device, the connection to the shop server may be operated automatically only if needed, and when the device is switched off, the list may be automatically transferred to the shop server.

The list may be stored at the customer premise apparatus and at the store server, as the customer wishes. This enables the store to prepare the products that the customers are inclined to purchase sight unseen. Other products, such as vegetables and fruits, etc., may be entered into the device and the list may simply be stored.

Prior to going to the store, the customer may send a message through the device alerting the store of his/her arrival. The store personnel or automated equipment may prepare the “store select” portion of the order, and alternatively may also provide the customer with a printed list of all other products marked as needed. Even if the customer visits the store without notification, the store computer may query and obtain the list from the home device as needed, and utilize the time the customer spends shopping for personally selected products to prepare the rest of the order. When the client goes to the checkout counter, the “store selected” portion of the order is waiting, and only the personally selected items need to be counted and billed. The customer then pays in cash or by card as is commonly done today, and the fear of electronic payment is avoided.

There is thus provided in accordance with a preferred embodiment of the present invention a method including placing an order of at least one shop selected item with a shop, the at least one shop selected item including a purchasable item that a consumer relies on the shop to select from a group of mutually equivalent items without the consumer having to see and select the purchasable item, preparing the order of the at least one shop selected item for pick-up by the consumer at the shop, going to the shop and choosing at least one personally selected item, the at least one personally selected item including a purchasable item that a consumer does not rely on the shop to select, and collecting the at least one shop selected item and the at least one personally selected item for purchase by the consumer.

The order may be placed with home apparatus, which is in communication with the shop via a communication link, such as with a shop main computer. The shop main computer may be further linked with at least one of a shop entrance subsystem of the shop, a packing zone subsystem of a packing department of the shop, and a checkout counter point of the shop.

In accordance with a preferred embodiment of the present invention the home apparatus is used as a notepad to create the order of the one or more shop selected items and/or personally selected items.

Further in accordance with a preferred embodiment of the present invention a message is sent to the shop alerting the shop of an arrival time of the consumer. The order of the one or more shop selected items and/or personally selected items may be prepared for pick-up by the consumer at the shop prior to the arrival of the consumer, and a separate bill may be provided for the one or more shop selected items.

Still further in accordance with a preferred embodiment of the present invention the consumer may arrive at the shop and interrogate an entrance subsystem to obtain a printed list of the one or more shop selected items and/or personally selected items.

Additionally in accordance with a preferred embodiment of the present invention the method includes billing the consumer for the one or more shop selected items and/or personally selected items, and providing a release note with an identification code for the consumer to leave the shop with the items.

In accordance with a preferred embodiment of the present invention the method further includes sending shopping information from the shop to the home apparatus, the information including at least one of information concerning new products, prices and special discounts.

### BRIEF DESCRIPTION OF THE DRAWINGS

The present invention may be understood and appreciated more fully from the following detailed description, taken in conjunction with the drawings in which:

FIG. 1 is a simplified pictorial illustration of a system and method in accordance with a preferred embodiment of the present invention, including home apparatus, a store computerized subsystem, a shopping area with entrance and checkout counter zone, and a remote packing zone;

FIGS. 2A, 2B, 2C are simplified illustrations of three different embodiments of the home apparatus of the system and method of FIG. 1;

FIGS. 3A, 3B, 3C are simplified illustrations of three different possibilities of positioning the home apparatus in a kitchen, in accordance with different embodiments of the present invention;

FIG. 4 is a simplified block diagram showing the home apparatus sequence and operation, in accordance with a preferred embodiment of the present invention;

FIG. 5 is a simplified block diagram showing the sequence of selecting the product at the home apparatus, in accordance with a preferred embodiment of the present invention:

FIG. 6 is a simplified block diagram showing the sequence and operation of the personal customer page, in accordance with a preferred embodiment of the present invention; and

FIG. 7 is a simplified block diagram showing the sequence and operation of the store computerized system including the entrance subsystem, the packing subsystem and the checkout counter subsystem, in accordance with a preferred embodiment of the present invention.

### DETAILED DESCRIPTION OF THE DRAWINGS

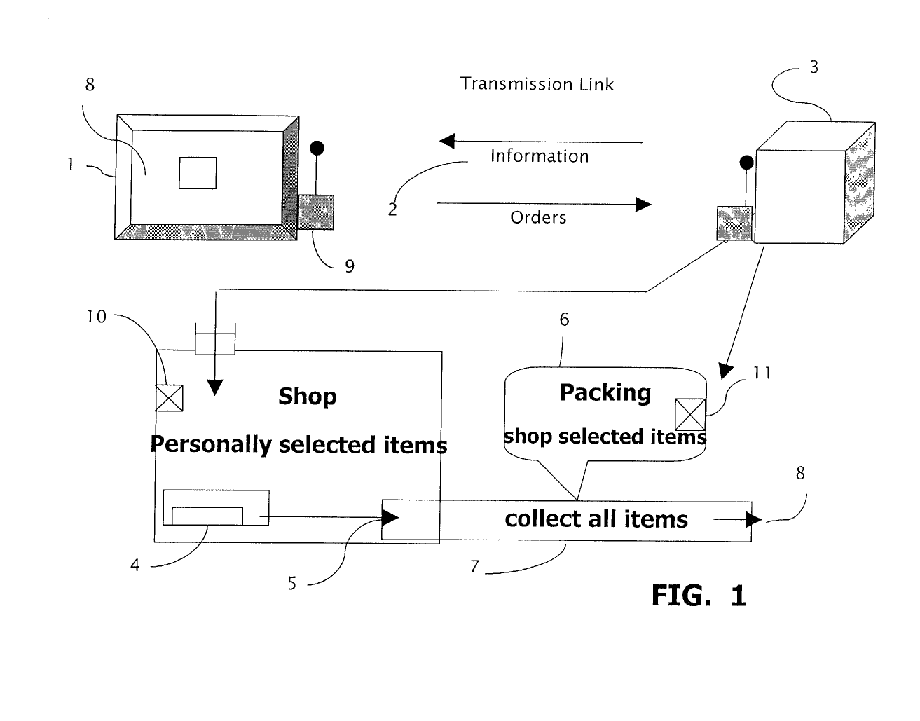

Reference is now made to FIG. 1, which illustrates an order entry system and method constructed and operative in accordance with a preferred embodiment of the present invention.

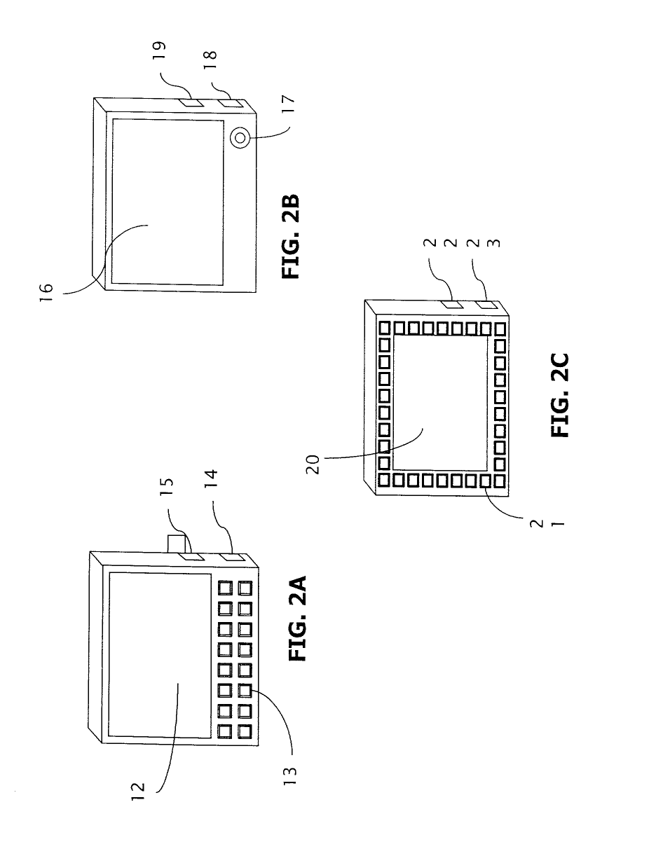

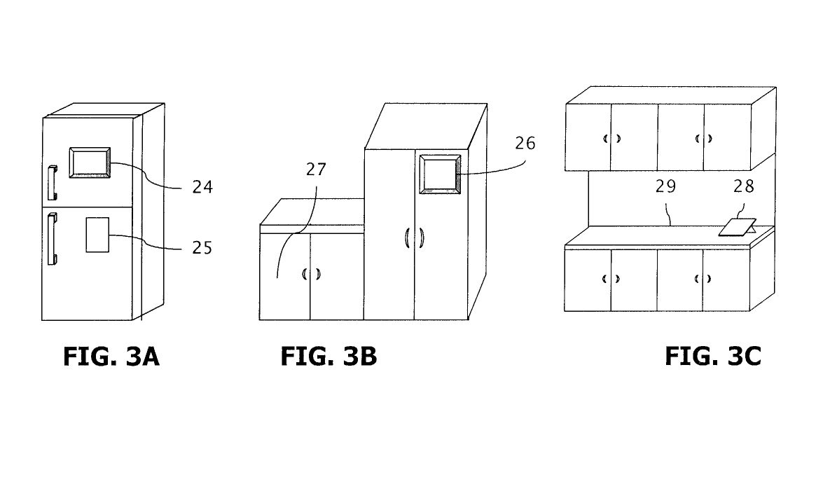

Home apparatus 1 may be positioned in a kitchen in a customer's house, as described further in detail with reference to FIGS. 3A-3C. Home apparatus 1 may have a display screen 8, and user interface devices to enable operation thereof, such as a keyboard, a touch screen or a remote control, as described further in detail with reference to FIGS. 2A-2C. A communication terminal 9 may be provided, which establishes a communication link 2 with a shop main computer 3 (also referred to as shop server 3 or store server 3, the terms shop and store being used interchangeably throughout). The link 2 may be a telephone line, or a cellular or radio communication link that enables bi-directional flow of information. The shop main computer 3 may be positioned at a control center, and may be connected to a shop entrance subsystem 10, a packing zone subsystem 11 of a packing department 6, and one or more checkout counters points 5.

The customer may use home apparatus 1 daily as a notepad to select and create the list of products that are needed. Home apparatus 1 preferably automatically divides the list into two groups: shop selected items and personally selected items. Prior to going to the shop, the customer may send a message from home apparatus 1 via the communication link 2 to the store server 3 alerting the store of his/her arrival. The shop main computer 3 may alert the packing department subsystem 11 of the customer arrival time and the final purchase list of the shop selected items. The packing department 6 may then prepare a package with all the shop selected items mentioned in the purchase list, and may provide a separate bill for the shop selected items. When the customer arrives at the shop, the customer may interrogate the entrance subsystem 10 and obtain a printed list of the store selected and personally selected items. The printed list may comprise two groups of items, one group comprising items that the shop has prepared and another group comprising items that the consumer must personally select. The customer may then enter a shopping area 4 of the shop, and shop for and collect the personally selected items. When the customer is finished shopping, he/she may go to the checkout counter point 5 and be billed for the two portions of the list, and receive a release note with an identification code. The customer may receive the package or packages at an exit zone 7 and leave the shop through an exit 8.

Reference is now made to FIGS. 2A-2C which illustrate three different examples of embodiments of the home apparatus 1. In FIG. 2A, home apparatus 1 includes a screen 12, a keyboard 13, a power terminal 14 and a communications terminal 15. In FIG. 2B, home apparatus 1 includes a touch screen 16, a main power switch 17, a power terminal 18 and a communications terminal 19. In FIG. 2C, home apparatus 1 includes a screen 20, a keyboard 21, a power terminal 22 and a communications terminal 23. It is appreciated that the present invention is not limited to these examples.

Reference is now made to FIGS. 3A-3C which illustrate three different possibilities of positioning the home apparatus in a kitchen, in accordance with different embodiments of the present invention. In FIG. 3A, a home apparatus 24 is magnetically attached to a refrigerator front 25. In FIG. 3B, a home apparatus 26 is attached to the front of one or more kitchen cabinets 27. In FIG. 3C, a home apparatus 28 is placed on a counter top 29. It is appreciated that the present invention is not limited to these examples.

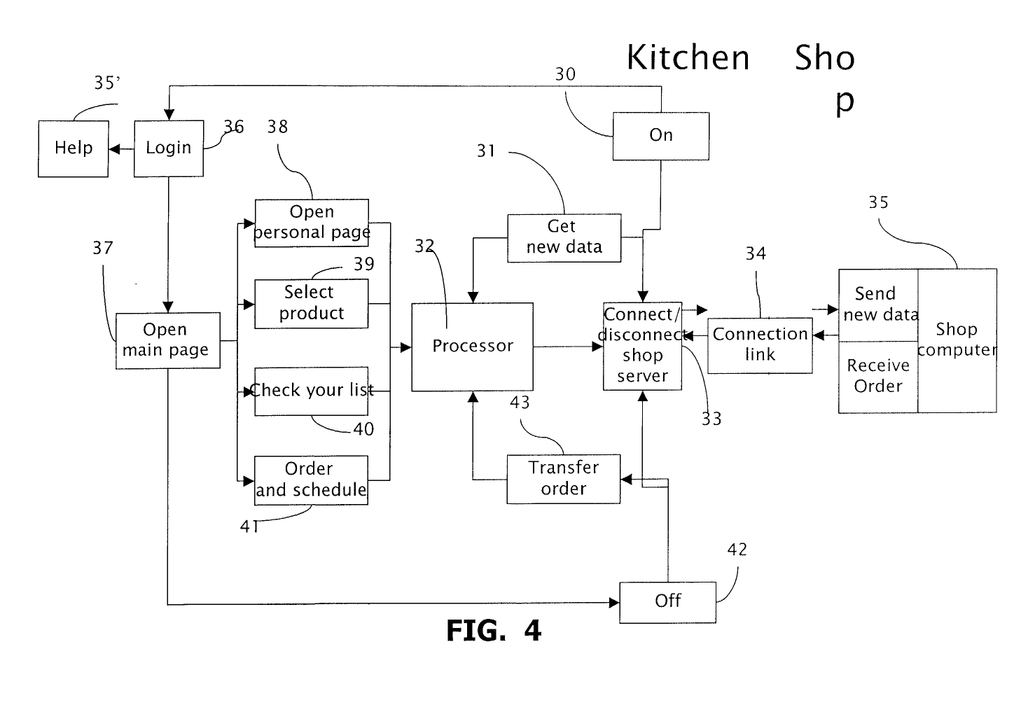

Reference is now made to FIG. 4, which illustrates a schematic block diagram of the sequence and operation of the home apparatus, in accordance with a preferred embodiment of the present invention. The apparatus may be switched on with a main power switch 30. Once the apparatus is turned on, a processor 32 may be readied to receive and process various commands, such as but not limited to, a command 31 to “get new data”, and a command 33 to “connect or disconnect the shop server”. A connection link 34 to a shop main server 35 may then be activated, and server 35 may transmit all “new data” to the home apparatus. The new data may include information concerning new products, prices, special discounts, etc. The home apparatus is now ready for user operation.

In order to operate the home apparatus, a user may have to perform a log-in 36, which opens a main page 37. In the event that log-in 36 fails, a help 35′ may be provided. In the main page 37, the user may choose various commands or windows, such as but not limited to, “open personal page” 38, “select product” 39, “check list” 40, and “send order and/or schedule” 41. When the user finishes, an “off” command 42 may be activated, and a “transfer order” command 43 may send the order to the shop server 35.

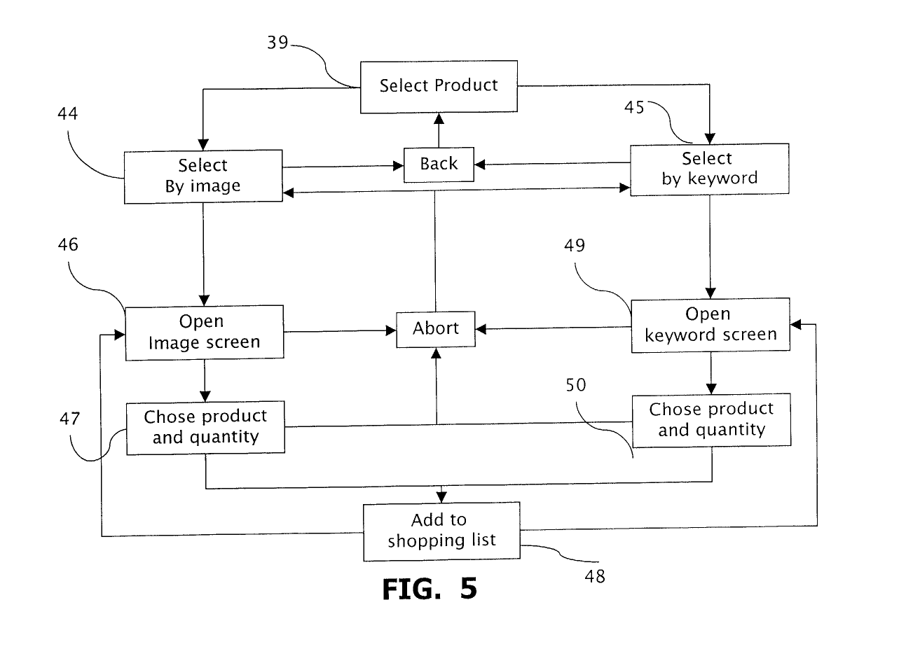

Reference is now made to FIG. 5, which illustrates a schematic block diagram of the sequence and operation of the product selection process at the home apparatus, in accordance with a preferred embodiment of the present invention. When the user chooses “select product” 39 at the main page 37, as previously shown in FIG. 4, a new page is opened. The user can now choose “select by image” 44 or “select by keyword” 45. As “select by image” 44 is activated, the image screen is opened at block 46 and the user may select the desired product and quantity at block 47. An “add to shopping list” command 48 may then be activated. Alternatively, if the “select by keyword” 45 is activated, a keyword page 49 is opened and the user may choose the desired product and quantity 50, and then add to the shopping list 48.

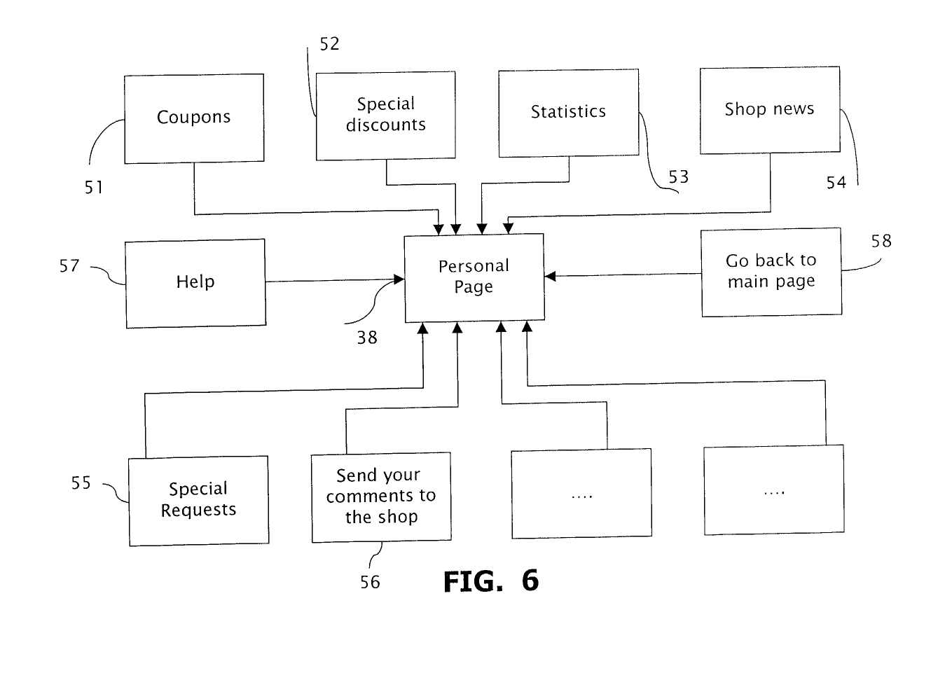

Reference is now made to FIG. 6, which illustrates the sequence and operation of the personal page 38, in accordance with a preferred embodiment of the present invention. At the personal page 38, the user may browse and choose “coupons” 51, “special discounts” 52, “statistics” 53, “shop news” 54, “special requests” 55, and many other optional possibilities, such as but not limited to, “send your comments to the shop” 56. At any stage the user may ask for “help” 57 or “go back to homepage” 58. The home apparatus 1 may communicate with the shop server 3 to browse the personal page 38 and its categories.

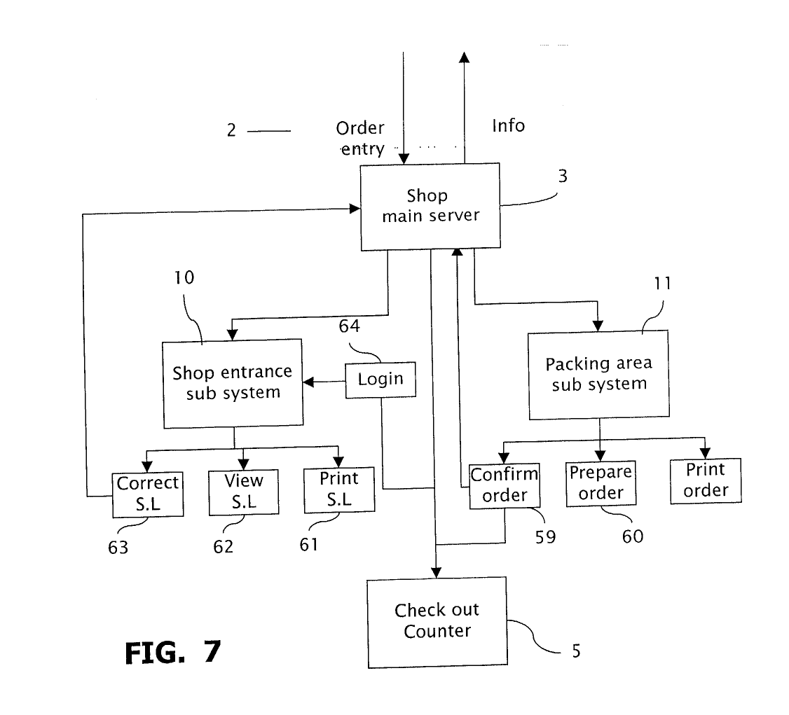

Reference is now made to FIG. 7, which illustrates the sequence, and operation of the shop computerized system including the main server 3, the shop entrance subsystem 10, the packing area subsystem 11, and the checkout counter subsystem 5, in accordance with a preferred embodiment of the present invention. Once the order is received from the home apparatus 1 through the communication link 2, it may be stored in the memory of the server 3 and an alert to “prepare an order” 60 may be given to the packing area subsystem 11. The shop personnel or an automated mechanism may then collect all the purchase list products and pack them to be ready and billed at the exit zone 7. A confirmation 59 may be sent to the main server 3 together with an identification number given to the package. When the customer reaches the shop, he/she may interrogate the entrance subsystem 10, perform a log-in 64, and view the shopping list 62, correct the list 63, and/or receive a printed list 61 of the order including the store selected and the personally selected items. The customer may collect all the personally selected items and go to the checkout counter 5. The customer is then billed, pays for both portions of the purchase, and receives the package at the exit zone 7 and returns home.

It will be appreciated by people skilled in the art that the present invention is not limited by what has been particularly shown and described hereinabove. Rather the scope of the present invention includes both combination and subcombination of the features described hereinabove as well as modifications and variations thereof which would occur to a person of skill in the art upon reading the foregoing description and which are not in the prior art.

What is claimed is:

1. A method comprising:
placing an order of at least one shop selected item with a shop, said at least one shop selected item comprising a purchasable item that a consumer relies on said shop to select from a group of mutually equivalent items without said consumer having to see and select said purchasable item; and
going to said shop and choosing at least one personally selected item, said at least one personally selected item comprising a purchasable item that a consumer does not rely on said shop to select.

2. The method according to claim 1 wherein said placing of said order comprises placing said order with home apparatus which is in communication with said shop via a communication link.

3. The method according to claim 2 and further comprising linking said home apparatus with a shop main computer.

4. The method according to claim 3 and further comprising linking said shop main computer with at least one of a shop entrance subsystem of said shop, a packing zone subsystem of a packing department of said shop, and a checkout counter point of said shop.

5. The method according to claim 2 and further comprising using said home apparatus as a notepad to create said order of said at least one shop selected item.

6. The method according to claim 2 and further comprising using said home apparatus as a notepad to create a list of said at least one personally selected item.

7. The method according to claim 2 and further comprising sending a message to said shop alerting said shop of an arrival time of said consumer.

8. The method according to claim 7 and further comprising preparing said order of said at least one shop selected item for pick-up by said consumer at said shop prior to said arrival of said consumer.

9. The method according to claim 8 and further comprising providing a separate bill for said at least one shop selected item.

10. The method according to claim 1 wherein said going to said shop and choosing at least one personally selected item comprises arriving at said shop and interrogating an entrance subsystem to obtain a printed list of at least one of said at least one shop selected item and said at least one personally selected item.

11. The method according to claim 10 wherein said printed list comprises two groups of items, one group comprising items that the shop has prepared and another group comprising items that the consumer must select.

12. The method according to claim 1 and further comprising billing said consumer for at least one of said at least one shop selected item and said at least one personally selected item.

13. The method according to claim 12 and further comprising providing a release note with an identification code for said consumer to leave said shop with at least one of said at least one shop selected item and said at least one personally selected item.

14. The method according to claim 2 and further comprising sending shopping information from said shop to said home apparatus, said information comprising at least one of information concerning new products, prices and special discounts.

15. The method according to claim 1 and further comprising:
preparing said order of said at least one shop selected item for pick-up by said consumer at said shop; and
collecting said at least one shop selected item and said at least one personally selected item for purchase by said consumer.
